(19) United States
(12) Patent Application Publication
(10) Pub. No.: US 2001/0052449 A1
(43) Pub. Date: Dec. 20, 2001

(54) Level lift and drop-off arrangement for vacuum transfer mechanism

(76) Inventor: Roy William Emery, Toronto (CA)

Correspondence Address: ROY W. EMERY, 1 DONINO COURT, TORONTO, ON, M4N 2H6, CA

(21) Appl. No.: 09/781,890

(22) Filed: Feb. 16, 2001

(30) Foreign Application Priority Data
May 31, 2000 (CA) 2,308,045

(51) Int. Cl. B65G 37/00; B65G 15/04

(52) U.S. Cl. 198/602; 198/689.1

(57) ABSTRACT

Lightweight moulded pulp trays or the like are attracted upward from transport on the upper side of a first conveyor to contact with the underside of the lower run of the perforated conveyor belt of a vacuum transfer mechanism by means of vacuum conditions transmitted through groups of perforations in said perforated belt, the location of said perforations in each group, and the timing of vacuum conditions transmitted through each perforation in each group being arranged to lift the forward and rearward proportions of each said product simultaneously with continuous support during transport to a selected location for simultaneous release of vacuum support for said forward and rearward portions of each said product, whereby to provide a level lift and drop-off for each product.

### PRIOR ART

The special arrangement of the vacuum transfer mechanism of this invention is created to replace a prior system of pushing rows of lightweight products from the upper surface at the terminal end~f travel of a first conveyor on to and along the smooth surface of an intervening slide plate to a selected point on another conveyor continuing in the same direction. The trailing edges of some moulded pulp articles, such as apple trays, do not present a convenient surface for the action of the pusher bar, and the special arrangement of this invention provides a useful and reliable method of transfer.

Earlier known vacuum lift and transfer mechanisms as described in U.S. Pat. No. 4,560,060 (Lenhart, 1985) and U.S. Pat. No. 5,651,313 (Kowalewski et al, 1997) make no provision for a secure level lift and drop-off, and the related security against troublesome misalignment of moulded trays and the like in transport to the selected location.

### SUMMARY OF THE INVENTION

A level lift and transfer arrangement is designed for use with a vacuum lift and transfer mechanism comprised of a belt conveyor having a foraminous belt made of rubber or other plastic materials and a vacuum chamber with a slotted bottom panel located directly above the lower run of said foraminous belt, said lower run of said belt being located directly above and close to the top surfaces of lightweight products being transported on a first conveyor and approaching the terminal end thereof, said products being lifted and attracted into contact with the underside of said lower run of said foraminous belt and maintained there by vacuum conditions transmitted through the slots of said bottom panel of said vacuum chamber, and thence through perforations in said foraminous belt into the space between said foraminous belt and the products travelling on said first conveyor, said products then being transported at the underside of said foraminous belt to a selected drop-off point beyond the terminal end of said first conveyor, with the lower run of said foraminous belt travelling in the same direction as said products on said first conveyor and at a controlled speed, then, according to this invention, the perforations in said foraminous belt are arranged in groups of at least two perforations, with at least one of said groups of perforations cooperating with each one of said products travelling on said first conveyor, with at least one perforation of each said group cooperating with a rearward portion of one of said products, and at least one other perforation of said group cooperating with a forward portion of said one product, said foraminous belt being controlled to travel at precisely the same speed as said products travelling on said first conveyor, and adjusted to have each product lifted simultaneously at both rearward and forward positions of said perforations in said group, the slots in said bottom panel of said vacuum chamber being continuous in the direction of travel of said products with alternating beginning and drop-off ends cooperating separately with the rearward and forward positions of said perforations in said groups, whereby to lift said forward and said rearward portions of each said product simultaneously and thus to maintain a level position at the pick-up point, and also to release said forward and rearward portions simultaneously, whereby to maintain a level position in releasing each said product at a selected drop-off point.

### BRIEF DESCRIPTION OF THE DRAWINGS

FIG. 1 is a plan view of a vacuum lift and transfer mechanism located directly above the terminal end of an approaching tray conveyor and the receiving end of a continuing conveyor, in order to transfer products from one conveyor to the other.

FIG. 2 is a diagrammatic cross-sectional plan view taken at line 1-1 of FIG. 3 to show the arrangement of continuing slots in the bottom panel of the vacuum distribution chamber of said vacuum lift and transfer mechanism and their correspondence with perforations in the transfer conveyor belt and the products being transferred.

FIG. 3 is a diagrammatic vertical cross-sectional view showing the location of said vacuum lift and transfer mechanism, together with its vacuum distribution chamber located immediately above the terminal end of the approaching tray conveyor and the receiving end of the continuing belt conveyor.

FIG. 4 is a cross-sectional plan view, taken at line 3-3 of FIG. 5 showing the arrangement of the continuous parallel lines of closely spaced perforations in the bottom panel of the vacuum distribution chamber superimposed over and cooperating with the larger and more widely spaced perforations in the transfer belt, and with the widely spaced meat trays being transferred from a belt conveyor to a collection box.

FIG. 5 is a diagrammatic vertical cross-sectional view showing the location of the vacuum lift and transfer mechanism, together with its vacuum distribution chamber and perforated transfer belt over the terminal end of the approaching belt conveyor and a collection box.

### DESCRIPTION OF THE PREFERRED EMBODIMENTS

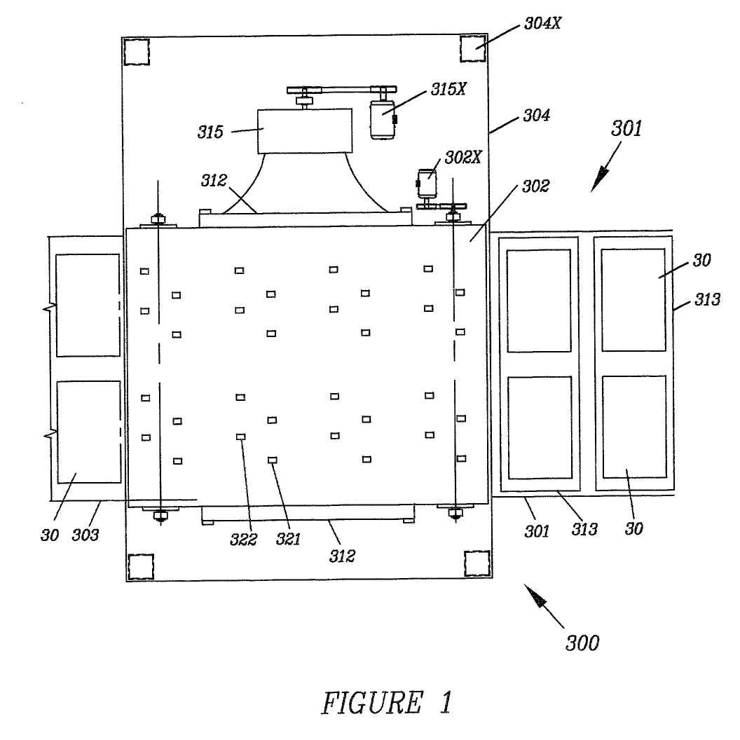

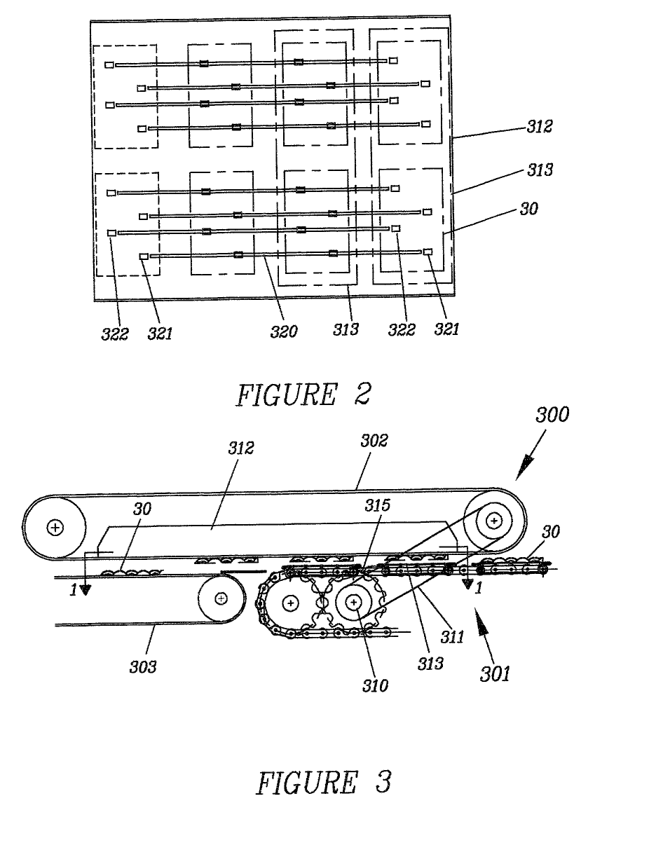

The vacuum lift and transfer conveyor 300 shown in FIGS. 1, 2 and 3 is comprised of a large air blower 315 driven by motor 315X to create vacuum conditions in a vacuum distribution chamber 312, together with a foraminous conveyor belt 302 driven by a helper motor 302X all supported together for height adjustment on platform 304. The bottom panel of said distribution chamber projects below said platform, and is provided with a series of long slots 320 continuing along the length of said bottom panel, and parallel to the sides thereof. The lower run of said belt 302 is maintained in close contact with the underside of said bottom panel, and vacuum conditions are transmitted through the slots 320, and thence through the cooperating perforations 321 and 322 in said belt 302, to the space between the underside of said belt 302 and the products 30 to be lifted and maintained in close contact with the underside of said belt 302 while they are being transferred along the travel path of said belt 302 to the drop-off point on to the receiving conveyor 303. The travel speed of said belt 302 is coordinated with the travel speed of the tray conveyor 301 by chain drive 311 so that one group of a series of groups of 4 perforations in said belt 302 travels directly over each product 30 transported on said tray conveyor 301, and at the same speed, with two of said perforations 322 being located at a forward portion of each said product 30, and two of said perforations 321 located at a rearward portion thereof, thereby to create a balanced lifting, transporting and drop-off force on each said product 30 throughout the period of their transfer between said tray conveyor 301 and said receiving conveyor 303, the cooperation between each of said products 30 and the corresponding group of perforations being regulated by the chain drive 311 between the shaft 310 of sprocket 315 of the tray conveyor 301 and the helper drive shaft of the transfer belt 302. The lift ends and the drop-off ends of slots 320 serving perforations 322 are spaced forward of the corresponding ends of the slots serving perforations 321 so that the forward and rearward perforations for each product act simultaneously at both the lift points and the dropoff points, whereby to maintain each said product 30 in a horizontal orientation during the entire transfer operation.

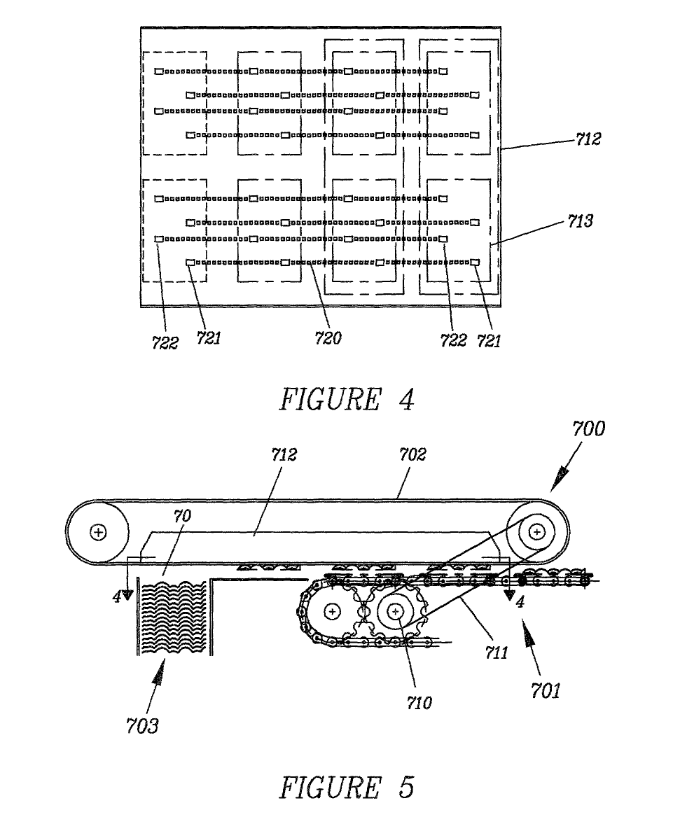

The vacuum lift and transfer mechanism 700 shown in FIGS. 4 and 5 is comprised of a vacuum distribution chamber 712 served by an air blower similar to the blower 315 shown in FIG. 1, together with a perforated conveyor belt 702 maintained in close contact with the underside of the bottom panel of said chamber 711, said bottom panel being perforated by a series of parallel rows of closely spaced round holes 720 as an alternative to the continuous slots in chambers 311 and 511, said rows of holes 720 being located along the travel paths of the perforations 721 and 722 in said belt 702, whereby to transmit vacuum conditions to the space between the underside of said belt 702 and the top surfaces of the products 70 and thereby to lift and maintain said products 70 in close contact with the underside of said belt conveyor 702 during the period of their transfer between conveyor 701 and the drop-off at collection box 703.

1. A level lift and drop-off arrangement for a vacuum lift and transfer mechanism, said vacuum lift and transfer mechanism being comprised of a belt conveyor with a foraminous belt made of rubber or other plastic material and a vacuum chamber with a slotted bottom panel located directly above the lower run of said foraminous belt, said lower run of said belt being located directly above and close to the top surfaces of lightweight products being transported on a first conveyor, and approaching the terminal end thereof, said products being lifted and attracted into contact with the underside of said lower run of said foraminous conveyor belt and maintained there by vacuum conditions transmitted through the slots of said slotted bottom panel of said vacuum chamber, and thence through perforations in said foraminous belt into the space between said foraminous belt and said products travelling on said first conveyor, said products then being transported at the underside of said foraminous belt to a selected drop-off point beyond the terminal end of said first conveyor, said vacuum lift and transfer mechanism having a level lift and drop-off arrangement where the lower run of said foraminous belt travels in the same direction as the lightweight products on said first conveyor and at a controlled speed, and where said perforations in said foraminous belt are arranged in groups of at least two perforations, with at least one of said groups of said perforations cooperating with each one of said products travelling on said first conveyor, with at least one perforation of said group cooperating with a rearward portion of said product and at least one other of said perforations of said group cooperating with a forward portion of said product, said foraminous belt being regulated to travel at precisely the same speed as said products travelling on said first conveyor and adjusted to have each product lifted simultaneously by both rearward and forward positions of said perforations in said group, the slots in said slotted bottom panel of said vacuum chamber being continuous in the direction of travel of said products with alternating beginning and drop-off ends coordinating separately with the forward and rearward positions of said perforations in said groups, whereby to lift said forward and rearward portions of each said product simultaneously and thus maintain a level position at the pick-up point, and also to release said forward and rearward portions simultaneously whereby to maintain a level position in releasing each said product at a selected drop-off point.

2. The level lift and level drop-off arrangement of claim 1, where the drop-off point is at a selected location on a third conveyor, and near the beginning end thereof.

3. The level lift and level drop-off arrangement of claim 1, where the drop-off point is a collection box.
